(19) United States
(12) Patent Application Publication
(10) Pub. No.: US 2013/0318563 A1
(43) Pub. Date: Nov. 28, 2013

(54) TELEVISION APPARATUS CONNECTED TO MULTIMEDIA TERMINAL APPARATUS AND TELEVISION SYSTEM FOR THE SAME

(71) Applicant: Nai-Chien CHANG, New Taipei City (TW)

(72) Inventor: Nai-Chien CHANG, New Taipei City (TW)

(21) Appl. No.: 13/836,013

(22) Filed: Mar. 15, 2013

(30) Foreign Application Priority Data
May 24, 2012 (TW) 101209857

(51) Int. Cl. H04N 21/414

(52) U.S. Cl. CPC H04N 21/414
USPC 725/110; 725/131; 725/134

(57) ABSTRACT

A television apparatus includes a first connection port for connecting to a multimedia terminal apparatus. The television apparatus receives television signals through a television signal input unit of the television apparatus. A monitor of the television apparatus displays the television signals. Therefore, the television apparatus is used as a conventional television. Moreover, the television apparatus is connected to the multimedia terminal apparatus through the first connection port. A mastership of the television apparatus is transferred from a first central processing unit of the television apparatus to a second central processing unit of the multimedia terminal apparatus when the multimedia terminal apparatus is connected to the television apparatus. The multimedia terminal apparatus is configured to process an operating system of the multimedia terminal apparatus. Therefore, the television apparatus is used as a smart television.

### BACKGROUND OF THE INVENTION

1. Field of the Invention

The present invention relates to a television, and especially relates to a television apparatus that the status of the television apparatus is switchable.

2. Description of the Related Art

In recent years, the standard of living has improved. Entertainment devices, such as televisions and computers, are more and more popular.

To take the television as an example, the conventional television receives television signals provided by the television dealer through the cable. The conventional television displays television programs on the monitor. The users may watch television programs on the convention television. However, the conventional television receives television signals provided by the television dealer passively. Therefore, what the users may watch will be determined by the television dealer. Moreover, the conventional television does not have any other functions. Therefore, the users are not satisfied with the conventional television.

Therefore, the smart television is provided in the market. The smart television is configured to process the operating system and the application programs, and is connected to the Internet. The users may take the smart television as a computer with a large size monitor. The smart television is more and more popular due to practicality and convenience.

However, the smart television is too expensive. Moreover, the smart television is not portable as the tablet computer or the smart phone although the smart television has powerful functions.

### SUMMARY OF THE INVENTION

In order to solve the above-mentioned problems, an object of the present invention is to provide a television apparatus. A conventional television will turn into a smart television by connecting to a multimedia terminal apparatus.

In order to solve the above-mentioned problems, another object of the present invention is to provide a television system. The television system includes a television apparatus and a multimedia terminal apparatus which is connectable to and removable from the television apparatus. The user may switch the television apparatus between the conventional television and the smart television.

In order to achieve the object of the present invention mentioned above, the television apparatus includes a first connection port. The television apparatus is connected to a multimedia terminal apparatus through the first connection port. The television apparatus receives television signals through a television signal input unit. A monitor of the television apparatus displays the television signals. The television apparatus is used as a conventional television. Moreover, the television apparatus is connected to the multimedia terminal apparatus through the first connection port. A mastership of the television apparatus is transferred from a first central processing unit of the television apparatus to a second central processing unit of the multimedia terminal apparatus when the television apparatus is connected to the multimedia terminal apparatus. The multimedia terminal apparatus is configured to process an operating system of the multimedia terminal apparatus. The television apparatus is used as a smart television.

The efficiency of the present invention is that the television apparatus is not only used as a conventional television for displaying television programs, but also connected to the multimedia terminal apparatus to be a television system. The mastership of the television system is switchable between the television apparatus and the multimedia terminal apparatus. The multimedia terminal apparatus is configured to process the operating system of the multimedia terminal apparatus and transmit video signals and audio signals to the television apparatus for displaying (playbacking) if the multimedia terminal apparatus has the mastership. Therefore, the television system of the present invention is used as a smart television.

In another word, the user may freely control the status of the television. Therefore, the problem of the conventional television (the functions are too few) and the problem of the smart television (too expensive) are solved.

### BRIEF DESCRIPTION OF DRAWING

FIG. 1 shows a diagram of the first embodiment showing that the multimedia terminal apparatus is not yet connected to the television apparatus.

FIG. 2 shows a diagram of the first embodiment showing that the multimedia terminal apparatus is connected to the television apparatus.

FIG. 3 shows a block diagram of the first embodiment of the television system of the present invention.

FIG. 4A shows a flow chart of the first embodiment of the present invention.

FIG. 4B shows a flow chart of the second embodiment of the present invention.

FIG. 5 shows a block diagram of the second embodiment of the television system of the present invention.

FIG. 6 shows a diagram of the second embodiment showing that the multimedia terminal apparatus is not yet connected to the television apparatus.

FIG. 7 shows a diagram of the third embodiment showing that the multimedia terminal apparatus is not yet connected to the television apparatus.

FIG. 8 shows a diagram of the fourth embodiment showing how the television system is used.

### DETAILED DESCRIPTION OF THE INVENTION

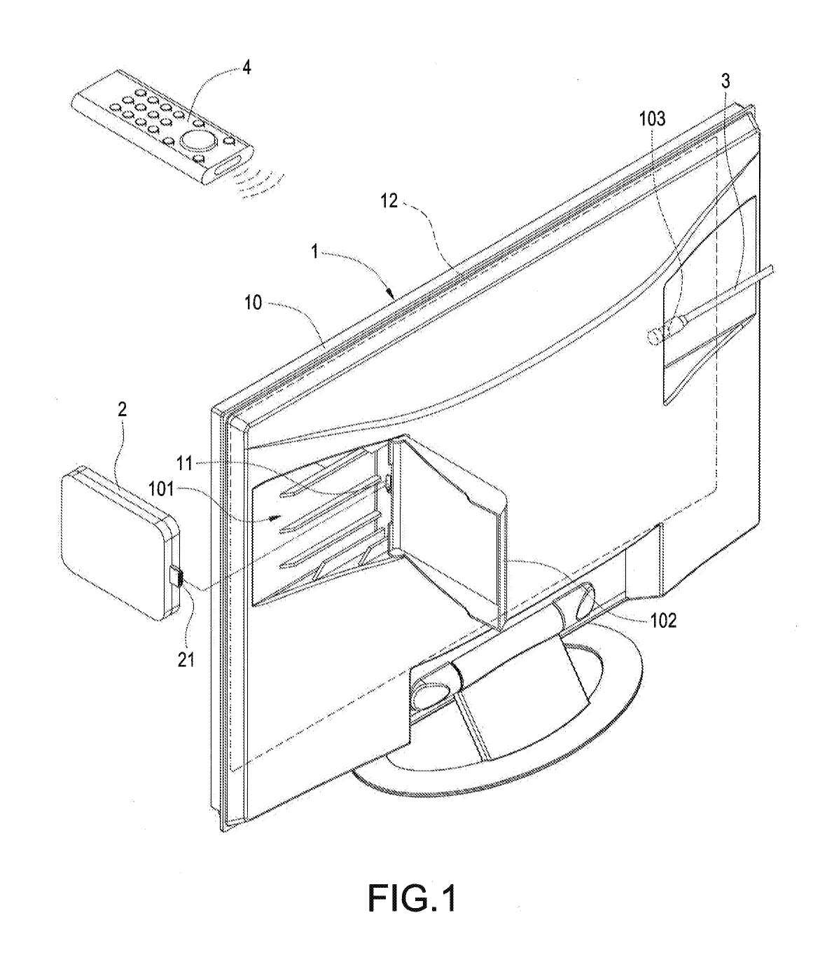

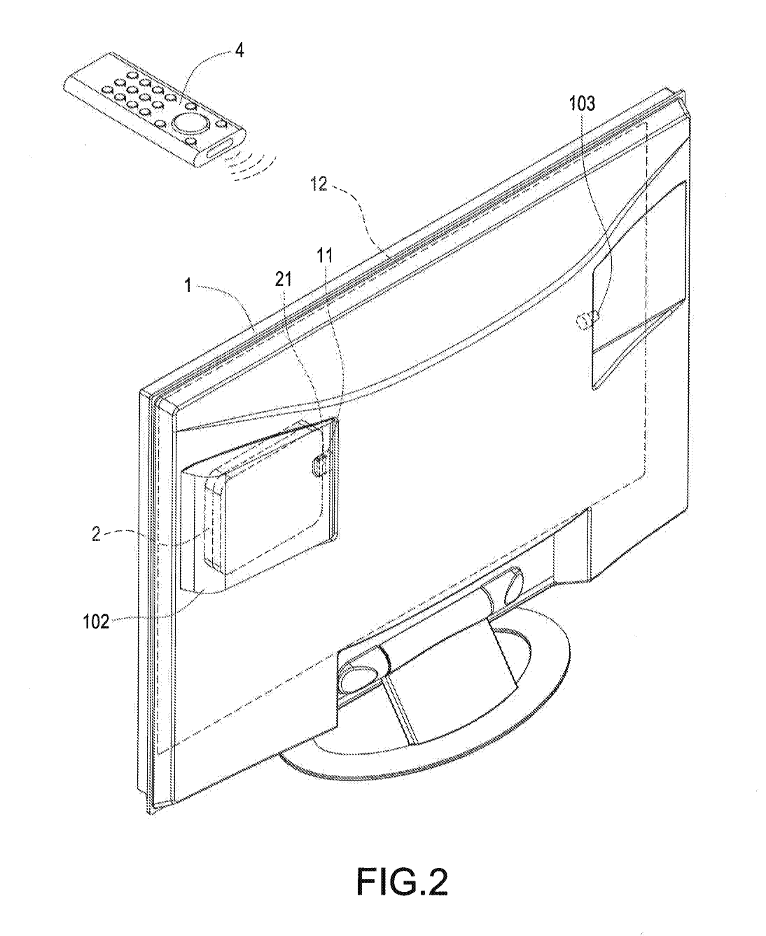

FIG. 1 shows a diagram of the first embodiment showing that the multimedia terminal apparatus is not yet connected to the television apparatus. FIG. 2 shows a diagram of the first embodiment showing that the multimedia terminal apparatus is connected to the television apparatus. A television apparatus 1 of the present invention is connected to a multimedia terminal apparatus 2. A television system of the present invention includes the television apparatus 1 and the multimedia terminal apparatus 2.

As shown in FIG. 1, the television apparatus 1 includes a casing 10 which includes an accommodating space 101 arranged in the back side of the casing 10. The television apparatus 1 further includes a first connection port 11 which is exposed to the accommodating space 101. Therefore, the television apparatus 1 is electrically connected to the multimedia terminal apparatus 2 through the first connection port 11 when the multimedia terminal apparatus 2 is arranged in the accommodating space 101. The casing 10 further includes a cover 102 which is able to be opened and closed. The cover 102 is closed when the multimedia terminal apparatus 2 is arranged in the accommodating space 101. Therefore, the television system includes the television apparatus 1 and the multimedia terminal apparatus 2.

The television apparatus 1 is connected to a cable 3 through a cable jack 103 of the television apparatus 1. Therefore, the television apparatus 1 receives television signals provided by the television dealer. A monitor 12 of the television apparatus 1 displays the television signals. In another word, the television apparatus 1 is used as a conventional television in normal status. Moreover, the user may use a control apparatus 4 (for example, an infrared remote control) to control the television apparatus 1 (for examples, turning on, turning off, switching programs, or adjusting the volume).

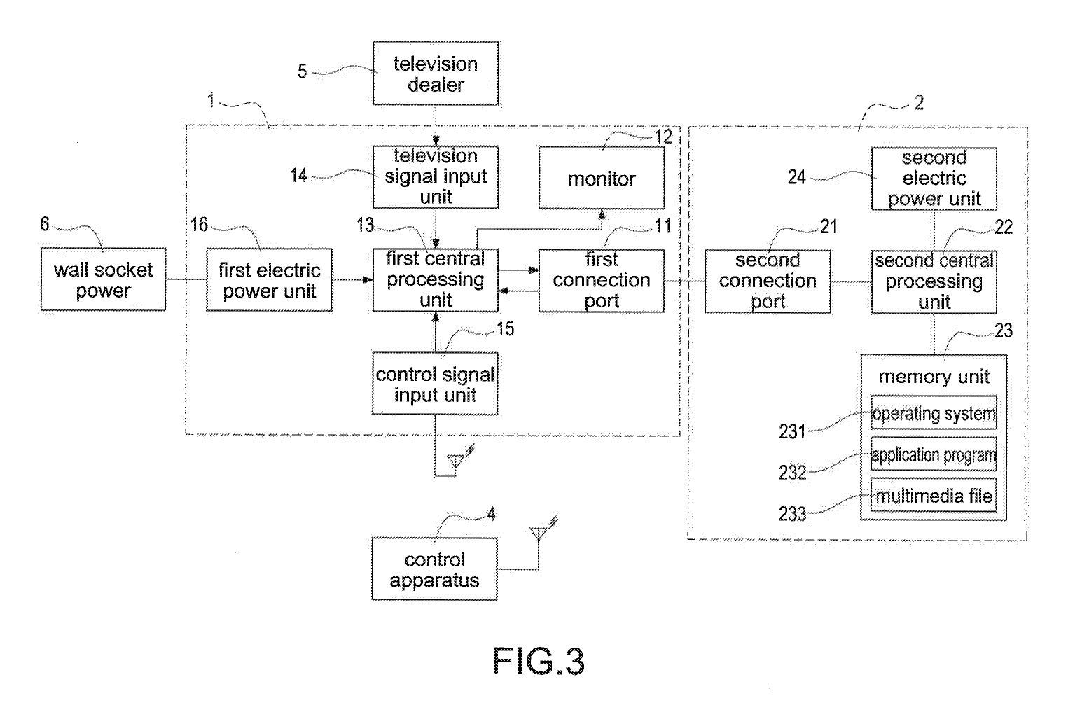

In this embodiment, the multimedia terminal apparatus 2 stores at least an operating system 231 (as shown in FIG. 3). The multimedia terminal apparatus 2 includes a second connection port 21 (as shown in FIG. 3) which is exposed outside. The multimedia terminal apparatus 2 is electrically connected to the first connection port 11 of the television apparatus 1 through the second connection port 21.

After the multimedia terminal apparatus 2 is connected to the television apparatus 1, the multimedia terminal apparatus 2 has the mastership of the television apparatus 1 (the mastership of the television system) according to the user's decision. Therefore, the multimedia terminal apparatus 2 is configured to process the operating system 231 automatically. The multimedia terminal apparatus 2 transmits video signals and audio signals generated by the operating system to the monitor 12 of the television apparatus 1 for displaying (playbacking). In another word, the multimedia terminal apparatus 2 is used as a computer without a monitor. The television apparatus 1 is used as a smart television after the television apparatus 1 is connected to the multimedia terminal apparatus 2. The television apparatus 1 is connected to the Internet through the operating system 231. The television apparatus 1 is configured to download multimedia data from the Internet.

More specifically, according to the user's decision, the television system is a conventional television (if the television apparatus 1 has the mastership) or a smart television (if the multimedia terminal apparatus 2 has the mastership) after the television apparatus 1 is connected to the multimedia terminal apparatus 2. Moreover, the television apparatus 1 is physically connected to the multimedia terminal apparatus 2. Therefore, the user may use the control apparatus 4 to control the multimedia terminal apparatus 2. The commands sent from the control apparatus 4 is sent to the multimedia terminal apparatus 2 through the television apparatus 1. Therefore, the operating system 231 of the multimedia terminal apparatus 2 is controlled.

FIG. 3 shows a block diagram of the first embodiment of the television system of the present invention. The television apparatus 1 includes the first connection port 11, the monitor 12, a first central processing unit 13, a television signal input unit 14, and a control signal input unit 15. The first central processing unit 13 is electrically connected to the first connection port 11, the monitor 12, the television signal input unit 14, and the control signal input unit 15.

The television signal input unit 14 is arranged at the cable jack 103. The television signal input unit 14 is connected to the cable 3. The television signal input unit 14 receives television signals provided by the television dealer 5 through the cable 3. The television signals received by the television signal input unit 14 are sent to the first central processing unit 13. The monitor 12 displays the television signals after the television signals are processed by the first central processing unit 13. Moreover, the monitor 12 could have a speaker. Therefore, the monitor 12 displays video signals and audio signals at the same time. Moreover, the television apparatus 1 could include a speaker (not shown in FIG. 3) as well. The monitor 12 displays video signals, and the speaker displays the audio signals.

The control signal input unit 15 includes, for examples, an infrared, a Bluetooth, or a radio frequency wireless transmission interface. The control signal input unit 15 wirelessly receives the control command sent from the control apparatus 4 (for example, a remote control). The control command received by the control signal input unit 15 is sent to the first central processing unit 13 for processing and executing (for examples, turning on, turning off, switching programs, or adjusting the volume).

The first connection port 11 is electrically connected to the multimedia terminal apparatus 2. Therefore, when the multimedia terminal apparatus 2 has the mastership of the television apparatus 1 (the television system), the first connection port 11 receives video signals and audio signals which are sent from the multimedia terminal apparatus 2. The video signals and the audio signals are sent to the monitor 12 for displaying (playbacking).

More specifically, in this embodiment, the user uses the control apparatus 4 to send the control command to the television apparatus 1, wherein the control command decides whether the television apparatus 1 or the multimedia terminal apparatus 2 has the mastership. According to the control command, the television apparatus 1 is configured to judge whether the mastership is kept at the television apparatus 1 or transferred to the multimedia terminal apparatus 2 when the television apparatus 1 receives the control command. The television apparatus 1 receives video signals and audio signals sent from the multimedia terminal apparatus 2 through the first connection port 11 when the multimedia terminal apparatus 2 has the mastership. The user can use the control apparatus 4 to control the multimedia terminal apparatus 2 directly.

The multimedia terminal apparatus 2 includes the second connection port 21, a second central processing unit 22, and a memory unit 23. The second central processing unit 22 is electrically connected to the second connection port 21 and the memory unit 23. The multimedia terminal apparatus 2 is electrically connected to the first connection port 11 of the television apparatus 1 through the second connection port 21. The television system of the present invention includes the television apparatus 1 and the multimedia terminal apparatus 2. The memory unit 23 stores the operating system 231. The second central processing unit 22 is configured to process the operating system 231 when the multimedia terminal apparatus 2 has the mastership. The video signals and audio signals generated by the operating system 231 are sent through the second connection port 21 to the monitor 12 for displaying.

As shown in FIG. 3, the memory unit 23 further stores at least an application program 232 and at least a multimedia file 233 (for examples, a music file or a video file). The user controls the multimedia terminal apparatus 2 to execute the application program 232 and the multimedia file 233. Video signals and audio signals generated by the application program 232 and the multimedia file 233 are sent to the television apparatus 1 for displaying (playbacking). Therefore, the television apparatus 1 is used as a smart television.

In this embodiment, the television apparatus 1 further includes a first electric power unit 16 electrically connected to the first central processing unit 13. The television apparatus 1 receives electric power supplied from a wall socket power 6 through the first electric power unit 16. The multimedia terminal apparatus 2 further includes a second electric power unit 24 (for example, a battery) electrically connected to the second central processing unit 22. The second electric power unit 24 supplies electric power to the multimedia terminal apparatus 2. Moreover, in another embodiment, the first connection port 11 and the second connection port 21 are connector interfaces which are able to transmit electric power. Therefore, the multimedia terminal apparatus 2 receives electric power supplied from the television apparatus 1 through the first connection port 11 and the second connection port 21 when the multimedia terminal apparatus 2 is connected to the television apparatus 1. In this embodiment, the multimedia terminal apparatus 2 may not require the second electric power unit 24. The present invention is not limited to it.

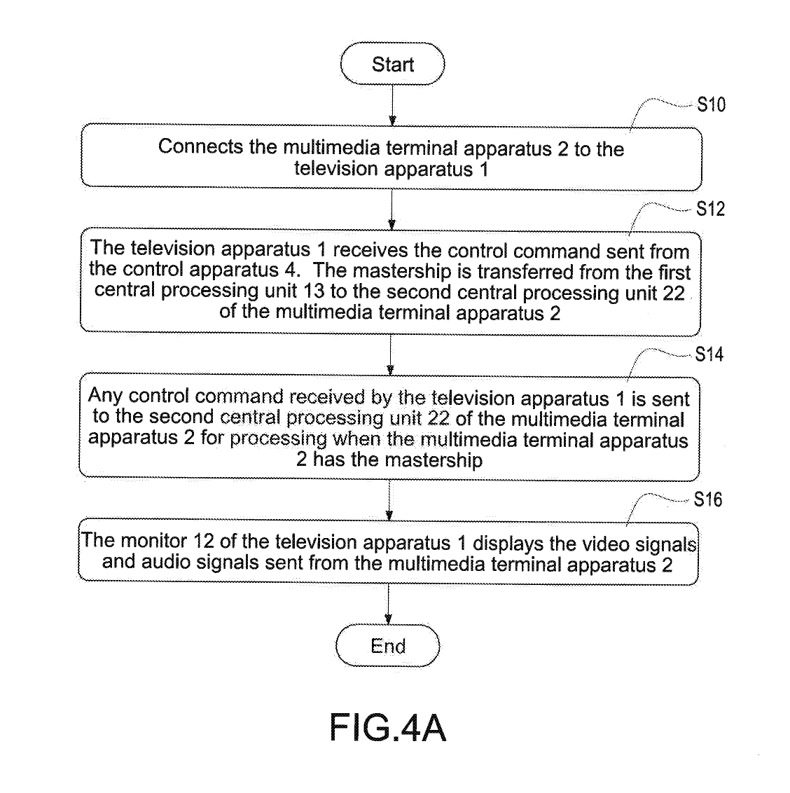

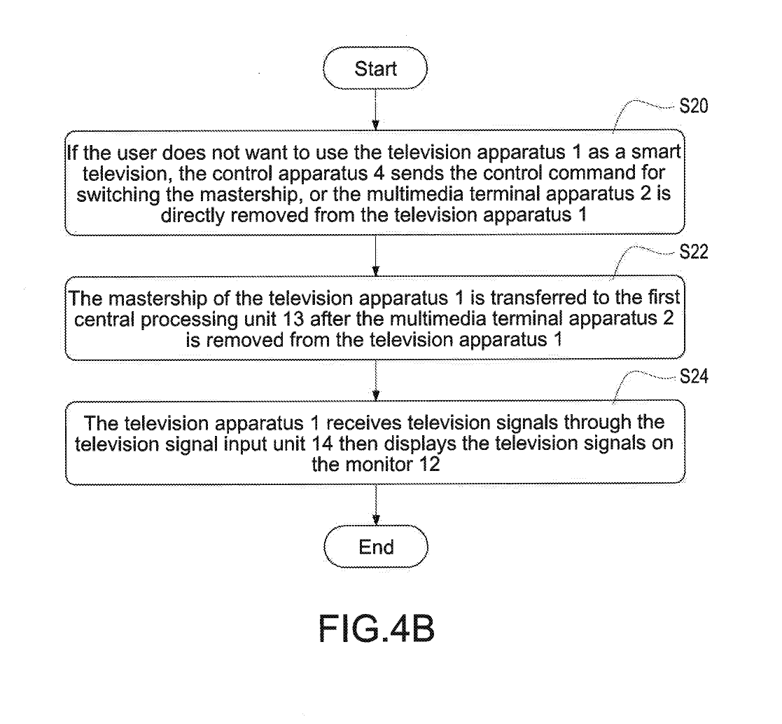

FIG. 4A shows a flow chart of the first embodiment of the present invention. The television apparatus 1 receives television signals then displays the television signals if the television apparatus 1 is not connected to the multimedia terminal apparatus 2. In another word, the television apparatus 1 is used as a conventional television.

As shown in FIG. 4, the process of the first embodiment of the present invention includes following steps.

S10: Connects the multimedia terminal apparatus 2 to the television apparatus 1.

S12: The television apparatus 1 receives the control command sent from the control apparatus 4. The mastership is transferred from the first central processing unit 13 to the second central processing unit 22 of the multimedia terminal apparatus 2.

The multimedia terminal apparatus 2 is configured to process the operating system 231, the application program 232, and the multimedia file 233 after the multimedia terminal apparatus 2 has the mastership.

S14: Any control command received by the television apparatus 1 is sent to the second central processing unit 22 of the multimedia terminal apparatus 2 for processing when the multimedia terminal apparatus 2 has the mastership.

S16: The monitor 12 of the television apparatus 1 displays the video signals and audio signals sent from the multimedia terminal apparatus 2.

Therefore, for the user, controlling the television apparatus 1 is equal to controlling a smart television which has an operating system (for examples, the Android system or the Windows system).

FIG. 4B shows a flow chart of the second embodiment of the present invention. The process of the second embodiment of the present invention includes following steps.

S20: If the user does not want to use the television apparatus 1 as a smart television, the control apparatus 4 sends the control command for switching the mastership, or the multimedia terminal apparatus 2 is directly removed from the television apparatus 1.

S22: The mastership of the television apparatus 1 is transferred to the first central processing unit 13 after the multimedia terminal apparatus 2 is removed from the television apparatus 1.

S24: The television apparatus 1 receives television signals through the television signal input unit 14 then displays the television signals on the monitor 12.

Therefore, the television apparatus 1 is used as a conventional television.

In the embodiments mentioned above, the quantity of the first connection port 11 is one, and the quantity of the second connection port 21 is one. The television apparatus 1 and the multimedia terminal apparatus 2 transmit the control command, the mastership, the video signals, the audio signals, the digital signals, and so on to each other through the first connection port 11 and the second connection port 21.

Moreover, the television apparatus 1 and the multimedia terminal apparatus 2 transmit both the digital signals and electric power through the first connection port 11 and the second connection port 21 if the first connection port 11 and the second connection port 21 are able to transmit electric power.

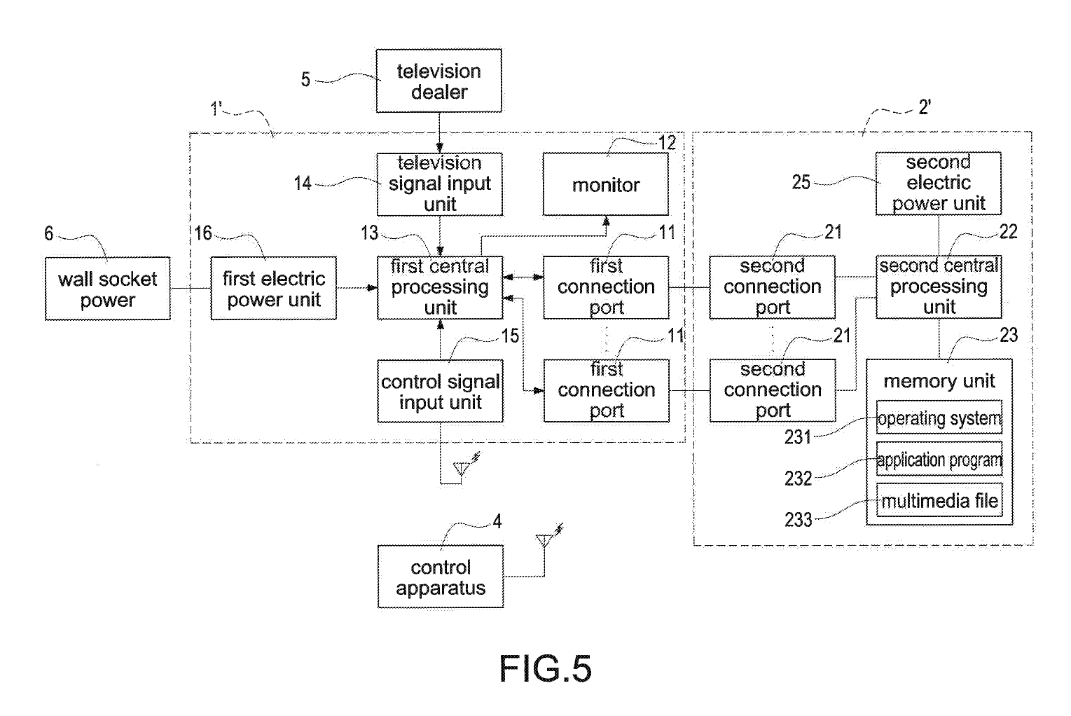

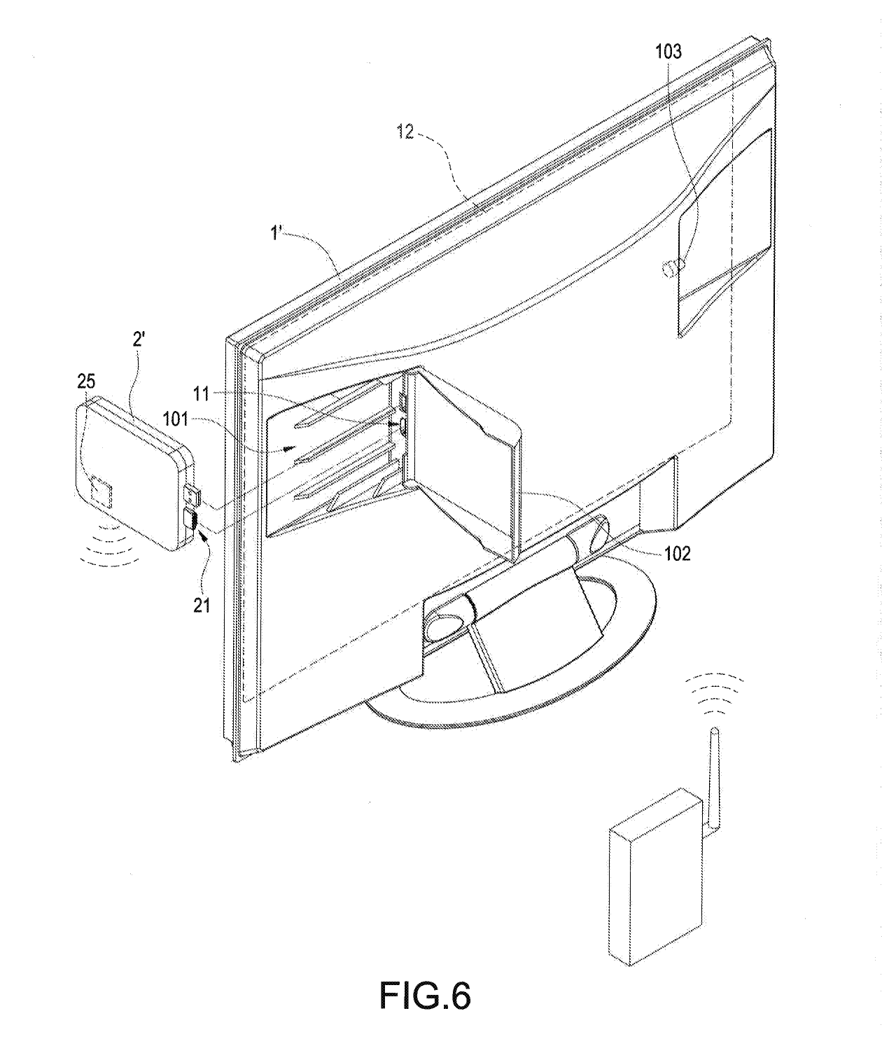

FIG. 5 shows a block diagram of the second embodiment of the television system of the present invention. FIG. 6 shows a diagram of the second embodiment showing that the multimedia terminal apparatus is not yet connected to the television apparatus. In this embodiment, the television system includes a television apparatus 1′ and a multimedia terminal apparatus 2′. The difference between the television apparatus 1′ and the television apparatus 1 is that the television apparatus 1′ includes a plurality of the first connection ports 11. The quantity of the second connection port 21 of the multimedia terminal apparatus 2′ is equal to the quantity of the first connection ports 11 of the television apparatus 1′. As shown in FIG. 6, the quantity of the first connection ports 11 is two, and the quantity of the second connection port 21 is two. The two first connection ports 11 and the two second connection ports 21 are used to transmit digital signals and electric power separately. More specifically, in this embodiment, the interface of one of the first connection ports 11 is different from the interface of the other first connection port 11. The interface of one of the second connection ports 21 is different from the interface of the other second connection port 21. Therefore, one of the first connection ports 11 is used to transmit digital signals, and the other first connection port 11 is used to transmit electric power. One of the second connection ports 21 is used to transmit digital signals, and the other second connection port 21 is used to transmit electric power.

Moreover, the quantity of the first connection port 11 is more than two (for example, three), and the quantity of the second connection port 21 is more than two (for example, three). The three first connection ports 11 and the three second connection ports 21 are used to transmit video signals, audio signals, and electric power separately. The quantities of the first connection port 11 and the second connection port 21 of the present invention are not limited.

As shown in FIG. 5, the multimedia terminal apparatus 2′ further includes a network unit 25 (for example, a Wi-Fi module) electrically connected to the second central processing unit 22. The multimedia terminal apparatus 2′ is wirelessly connected to a wireless access point 7 through the network unit 25. Therefore, the multimedia terminal apparatus 2′ is connected to the Internet. The multimedia terminal apparatus 2′ transmits the video signals and audio signals (which are fetched from the Internet) to the television apparatus 1′ for displaying if the multimedia terminal apparatus 2′ has the mastership.

The first connection port 11 of the television apparatus 1 (the television apparatus 1′) is, for example but not limited to, a female connector (for example, a high definition multimedia interface female connector). The second connection port 21 (opposite to the first connection port 11) of the multimedia terminal apparatus 2 (the multimedia terminal apparatus 2′) is, for example but not limited to, a male connector (for example, a high definition multimedia interface male connector).

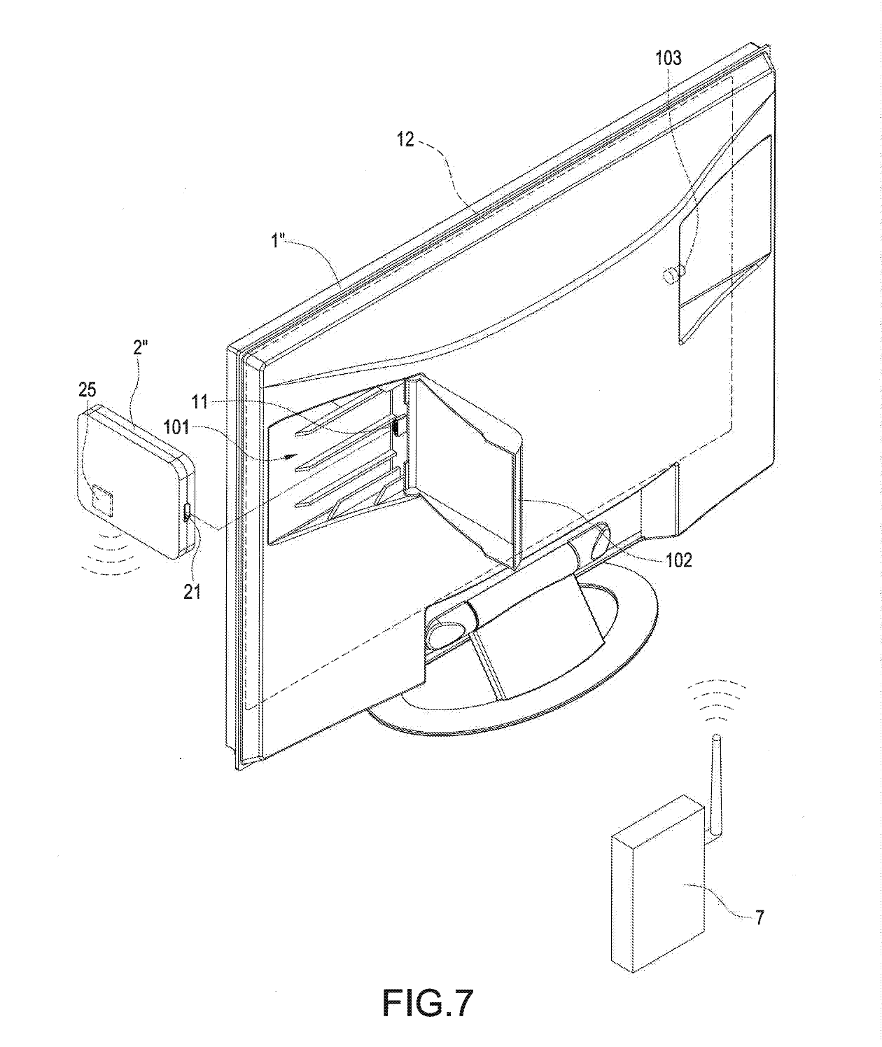

FIG. 7 shows a diagram of the third embodiment showing that the multimedia terminal apparatus is not yet connected to the television apparatus. In this embodiment, the television system includes a television apparatus 1″ and a multimedia terminal apparatus 2″. The first connection port 11 of the television apparatus 1″ is a male connector. The second connection port 21 of the multimedia terminal apparatus 2″ is a female connector. More specifically, the first connection port 11 is a high definition multimedia interface male connector. The second connection port 21 is a high definition multimedia interface female connector. Moreover, as mentioned above, the quantities of the first connection port 11 and the second connection port 21 of the present invention are not limited.

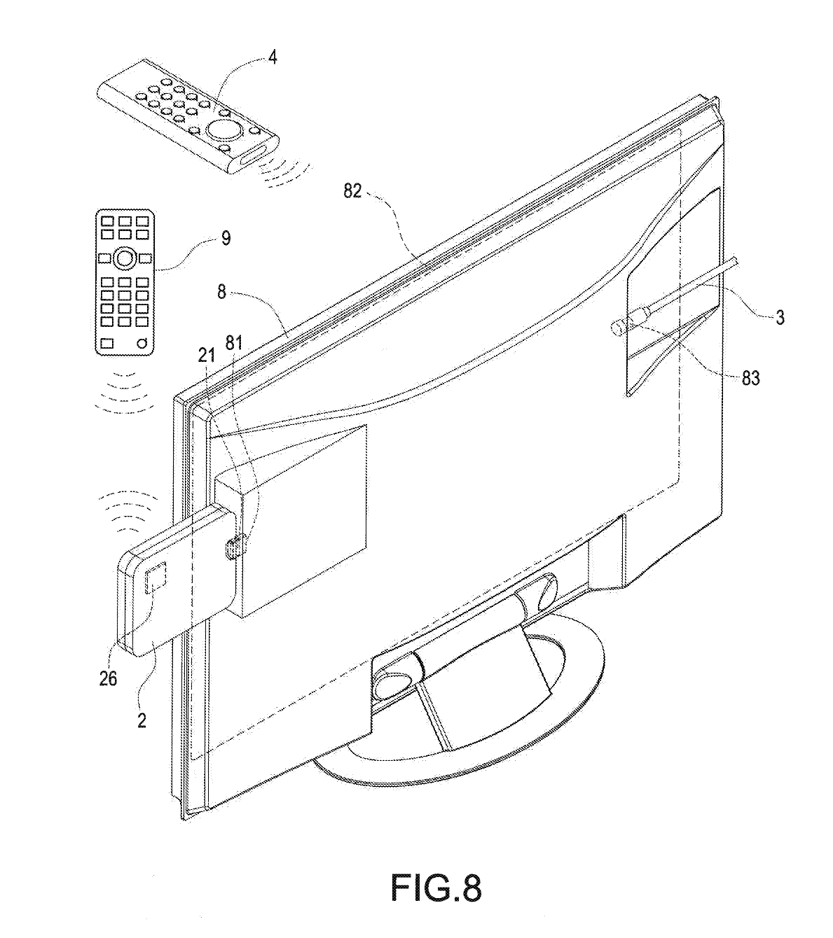

FIG. 8 shows a diagram of the fourth embodiment showing how the television system is used. The feature of the present invention is that the television apparatus 1 is used as a smart television when the multimedia terminal apparatus 2 is connected to the television apparatus 1. The television apparatus 1 is used as a conventional television when the multimedia terminal apparatus 2 is removed from the television apparatus 1. The television apparatus 1 and the multimedia terminal apparatus 2 are able to be used separately.

As shown in FIG. 8, the television apparatus 1 is used as a conventional television. The multimedia terminal apparatus 2 is carried and connected to a conventional television 8. The conventional television 8 includes a connection port 81, a monitor 82, and a cable jack 83. The conventional television 8 is connected to the cable 3 through the cable jack 83 for receiving television signals. Then, the monitor 82 displays the television signals. Moreover, the conventional television 8 is connected to the multimedia terminal apparatus 2 through the connection port 81 (for example, a high definition multimedia interface connector) for receiving video signals and audio signals sent from the multimedia terminal apparatus 2.

In this embodiment, the mastership is not transferred from the conventional television 8 to the multimedia terminal apparatus 2. The control apparatus 4 is configured to switch the signal input source from the cable jack 83 to the connection port 81. The conventional television 8 receives the video signals and audio signals sent from the multimedia terminal apparatus 2 through the connection port 81. Then, the monitor 82 displays the video signals and audio signals. In another word, in this embodiment, the conventional television 8 and the multimedia terminal apparatus 2 do not transmit the control command to each other. The control apparatus 4 is able to control the conventional television 8 only. The control apparatus 4 is not able to control the multimedia terminal apparatus 2.

As shown in FIG. 8, the multimedia terminal apparatus 2 further includes an input unit 26 electrically connected to the second central processing unit 22. An input apparatus 9 sends a control command to the input unit 26 to control the multimedia terminal apparatus 2 (for examples, processing the operating system 231, the application program 232, and the multimedia file 233).

Moreover, the multimedia terminal apparatus 2 wirelessly receives the control signal (for mastership switching) through the input unit 26 when the multimedia terminal apparatus 2 is connected to the television apparatus 1. Then, the control signal is sent to the first central processing unit 13 of the television apparatus 1. The first central processing unit 13 is configured to control the switching of the mastership according to the control signal. Moreover, the control apparatus 4 (or the input apparatus 9) is configured to control the television system as well. The present invention is not limited to it.

The television apparatus 1 and the multimedia terminal apparatus 2 are able to be used separately or together (as a smart television system). Therefore, the present invention is flexible.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A television apparatus applied to a multimedia terminal apparatus, the television apparatus connected to a cable for receiving television signals provided by a television dealer, the television apparatus including:
a television signal input unit for receiving the television signals;
a first central processing unit electrically connected to the television signal input unit, the first central processing unit configured to process the television signals;
a monitor electrically connected to the first central processing unit, the monitor displaying the television signals; and
at least a first connection port electrically connected to the first central processing unit, the first connection port connected to the multimedia terminal apparatus, the multimedia terminal apparatus configured to process an operating system,
wherein the television apparatus is configured to decide a mastership of the television apparatus being belonged to the first central processing unit or belonged to the multimedia. terminal apparatus according to a control command received by the television apparatus when the television apparatus is connected to the multimedia terminal apparatus.

2. The television apparatus in claim 1, further including a control signal input unit electrically connected to the first central processing unit, the control signal input unit wirelessly receiving the control command.

3. The television apparatus in claim 1, wherein the multimedia terminal apparatus includes:
a memory unit for storing the operating system;
a second central processing unit electrically connected to the memory unit, the second central processing unit configured to process the operating system; and
at least a second connection port electrically connected to the second central processing unit and the first connection port, a quantity of the second connection port equal to a quantity of the first connection port of the television apparatus,
wherein the multimedia terminal apparatus is configured to send video signals and audio signals generated by the operating system through the second connection port to the television apparatus when the multimedia terminal apparatus has the mastership, the television apparatus playbacking content of the video signals and the audio signals.

4. The television apparatus in claim 3, further including a casing which includes an accommodating space, the first connection port exposed to the accommodating space, the multimedia terminal apparatus arranged in the accommodating space, the casing further including a cover; the cover is able to be opened and closed.

5. The television apparatus in claim 4, wherein the first connection port is a high definition multimedia interface male connector; the second connection port is a high definition multimedia interface female connector.

6. The television apparatus in claim 4, wherein the first connection port is a high definition multimedia interface female connector; the second connection port is a high definition multimedia interface male connector.

7. The television apparatus in claim 4, wherein the first connection port transmits electric power; the second connection port transmits electric power; the multimedia terminal apparatus receives electric power from the television apparatus through the first connection port and the second connection port.

8. The television apparatus in claim 4, wherein the quantity of the first connection ports is two; the quantity of the second connection port is two; the two first connection ports and the two second connection ports are used to transmit digital signals and electric power separately.

9. The television apparatus in claim 4, wherein the multimedia terminal apparatus further includes a network unit electrically connected to the second central processing unit; the multimedia terminal apparatus is wirelessly connected to a wireless access point through the network unit for connecting to an interact.

10. A television system including:
a television apparatus connected to a cable for receiving television signals provided by a television dealer, the television apparatus including a first central processing unit for processing the television signals, the television apparatus further including a monitor for displaying the television signals; and
a multimedia terminal apparatus storing an operating system, the multimedia terminal apparatus including a second central processing unit for processing the operating system,
wherein the television system is configured to decide a mastership of the television system being belonged to the television apparatus or belonged to the multimedia terminal apparatus according to a control command received by the television system then the television apparatus is connected to the multimedia terminal apparatus; the multimedia terminal apparatus sends video signals and audio signals generated by the operating system to the monitor of the television apparatus when the multimedia terminal apparatus has the mastership, the television apparatus playbacking content of the video signals and the audio signals.

11. The television system in claim 10, wherein the television apparatus further includes:
a television signal input unit electrically connected to the first central processing unit, the television signal input unit connected to the cable, the television signal input unit receiving the television signals; and
at least a first connection port electrically connected to the first central processing unit and the multimedia terminal apparatus, the first connection port receiving the video signals and audio signals sent from the multimedia terminal apparatus.

12. The television system in claim 11, wherein the multimedia terminal apparatus further includes:
a memory unit electrically connected to the second central processing unit, the memory unit storing the operating system; and
at least a second connection port electrically connected to the second central processing unit and the first connection port, a quantity of the second connection port equal to a quantity of the first connection port of the television apparatus, the multimedia terminal apparatus sending the video signals and audio signals generated by the operating system to the television apparatus, the television apparatus playbacking content of the video signals and the audio signals.

13. The television system in claim 12, wherein the television apparatus further includes a control signal input unit electrically connected to the first central processing unit; the control signal input unit wirelessly receives the control command.

14. The television system in claim 12, wherein the multimedia terminal apparatus further includes an input unit electrically connected to the second central processing unit; the input unit wirelessly receives the control command.

15. The television system in claim 12, wherein the television apparatus further includes a casing which includes an accommodating space; the first connection port is exposed to the accommodating space; the multimedia terminal apparatus is arranged in the accommodating space; the casing further includes a cover; the cover is able to be opened and closed.

16. The television system in claim 12, wherein the multimedia terminal apparatus further includes a network unit electrically connected to the second central processing unit; the multimedia terminal apparatus is wirelessly connected to a wireless access point through the network unit for connecting to an internet.

17. The television system in claim 12, wherein the first connection port is a high definition multimedia interface male connector; the second connection port is a high definition multimedia interface female connector.

18. The television system in claim 12, wherein the first connection port is a high definition multimedia interface female connector; the second connection port is a high definition multimedia interface male connector.

19. The television system in claim 12, wherein the first connection port transmits electric power; the second connection port transmits electric power; the multimedia terminal apparatus receives electric power from the television apparatus through the first connection port and the second connection port.

20. The television system in claim 12, wherein the quantity of the first connection ports is two; the quantity of the second connection port is two; the two first connection ports and the two second connection ports are used to transmit digital signals and electric power separately.
